(19) United States
(12) Patent Application Publication
(10) Pub. No.: US 2009/0085471 A1
(43) Pub. Date: Apr. 2, 2009

(54) Organic El Display Device

(75) Inventor: Hiroki Tsujimura, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: Rohm Co., Ltd., Kyoto (JP)

(21) Appl. No.: 12/224,530

(22) PCT Filed: Mar. 1, 2007
(86) PCT No.: PCT/JP2007/053887

§ 371 Date: Aug. 28, 2008

(30) Foreign Application Priority Data
Mar. 7, 2006 (JP) 2006-060793

(51) Int. Cl. H01J 1/62

(52) U.S. Cl. 313/504

(57) ABSTRACT

An organic EL display device (A1) includes a transparent substrate (1), an anode electrode (2) and a cathode electrode (3) laminated on the substrate (1), and a plurality of light emitting layers (5) arranged between the anode electrode (2) and the cathode electrode (3) and made of an organic layer. The light emitting layers (5) are separated from each other by spaces (51) in an in-plane direction of the substrate (1). The organic EL display device further includes a reflective surface (4a) covering at least part of a respective one of the spaces (51) and inclined to come closer to the substrate (1) as proceeding from one of the light emitting layers (5) toward adjacent one of the light emitting layers (5).

### TECHNICAL FIELD

The present invention relates to an organic EL display device including an organic layer disposed between two electrodes to emit light upon application of an electric field to the organic layer.

### BACKGROUND ART

FIG. 13 shows an example of conventional organic EL display device (see e.g. Patent Document 1). The illustrated organic EL display device X includes a substrate 91, an anode electrode 92, a cathode electrode 93 and a plurality of light emitting layers 95. The light emitting layers are made of an organic material so as to emit blue light when voltage is applied between the anode electrode 92 and the cathode electrode 93. The light emitting layers 95 are mutually separated by insulating layers 98. As seen from the figure, color conversion layers 96R and 96G are provided below the left two of the three adjacent light emitting layers 95 via a protective layer 94. The color conversion layers 96R and 96G perform wavelength conversion with respect to the blue light emitted from the light emitting layers 95 to change the light into red light and green light, respectively. Filters 97R, 97G and 97B are arranged below the light emitting layers 95. Each of the filters 97R, 97G and 97B selectively passes the light in the wavelength range peculiar to the red, green or blue color to enhance the chroma of the color. The thus configured organic EL display device X displays color images at a display region (not shown) made up of a plurality of pixels for red, green and blue.

Patent Document 1: JP-A-10-162958

When a voltage is applied, the light emitting layers 95 made of an organic material emit light not only in the vertical direction but also in the horizontal direction in the figure. The light in the horizontal direction sometimes has the luminance which is substantially equal to or higher than the light in the vertical direction. In the organic EL display device X, however, only the light in the vertical direction is emitted from the display region, and the light in the horizontal direction is absorbed in the device. Further, the light traveling downward from the light emitting layers 95 pass through the anode electrode 92. To pass the light emitted from the light emitting layers 95 while enabling a voltage to be applied to the light emitting layers 95, the anode electrode 92 is structured as a transparent electrode made of e.g. ITO (Indium Tin Oxide). However, although the anode electrode 92 is a transparent electrode, the light from the light emitting layers 95 is inevitably attenuated by passing through the anode electrode. Thus, the organic EL display device X still has room for improvement with respect to the brightness of the display region.

### DISCLOSURE OF THE INVENTION

The present invention has been proposed under the circumstances described above. It is, therefore, an object of the present invention to provide an organic EL display device that is capable of high-brightness image display.

According to a first aspect of the present invention, there is provided an organic EL display device comprising a transparent substrate, an anode electrode and a cathode electrode laminated on the substrate, and a plurality of light emitting layers arranged between the anode electrode and the cathode electrode and made of an organic layer. The light emitting layers are separated from each other by spaces in an in-plane direction of the substrate. The organic EL display device further includes a reflective surface covering at least part of a respective one of the spaces and inclined to come closer to the substrate as proceeding from one of the light emitting layers toward adjacent one of the light emitting layers.

Preferably, the reflective surface may be made of metal.

Preferably, the organic EL display device may further comprise color conversion layers provided in the spaces.

Preferably, each of the anode electrode and the cathode electrode may comprise an opaque conductor.

Preferably, one of the anode electrode and the cathode electrode may be closer to the substrate than the other is, and the closer one may be smaller in size than each of the spaces, as viewed in the direction in which the light emitting layers are separated from each other.

### BRIEF DESCRIPTION OF THE DRAWINGS

FIG. 1 is a sectional view showing a principal portion of an organic EL display device according to a first embodiment of the present invention.

FIG. 2 is an enlarged sectional view showing a principal portion of the organic EL display device of FIG. 1.

FIG. 3 is a sectional view showing the step of forming a filter and a color conversion layer on a substrate in a method for manufacturing the organic EL display device shown in FIG. 1.

FIG. 4 is a sectional view showing the step of forming an anode electrode in a method for manufacturing the organic EL display device shown in FIG. 1.

FIG. 5 is a sectional view showing the step of forming a color conversion layer and an insulating layer in a method for manufacturing the organic EL display device shown in FIG. 1.

FIG. 6 is a sectional view showing the step of forming a metal member in a method for manufacturing the organic EL display device shown in FIG. 1.

FIG. 7 is a sectional view showing the step of forming an insulating layer in a method for manufacturing the organic EL display device shown in FIG. 1.

FIG. 8 is a sectional view showing the step of forming a light emitting layer in a method for manufacturing the organic EL display device shown in FIG. 1.

FIG. 9 is a sectional view showing a principal portion of an organic EL display device according to a second embodiment of the present invention.

FIG. 10 is a sectional view showing a principal portion of an organic EL display device according to a third embodiment of the present invention.

FIG. 11 is a sectional view showing a principal portion of an organic EL display device according to a fourth embodiment of the present invention.

FIG. 12 is a sectional view showing a principal portion of an organic EL display device according to a fifth embodiment of the present invention.

FIG. 13 is a sectional view showing the principal portion of a conventional organic EL display device.

### BEST MODE FOR CARRYING OUT THE INVENTION

Preferred embodiments of the present invention will be described below with reference to the accompanying drawings.

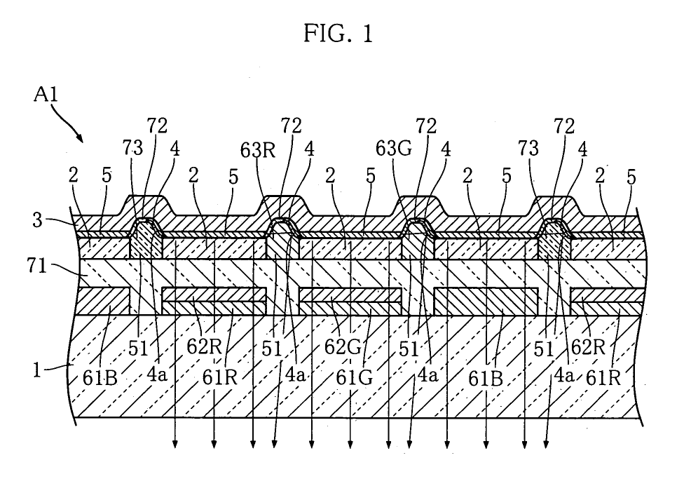

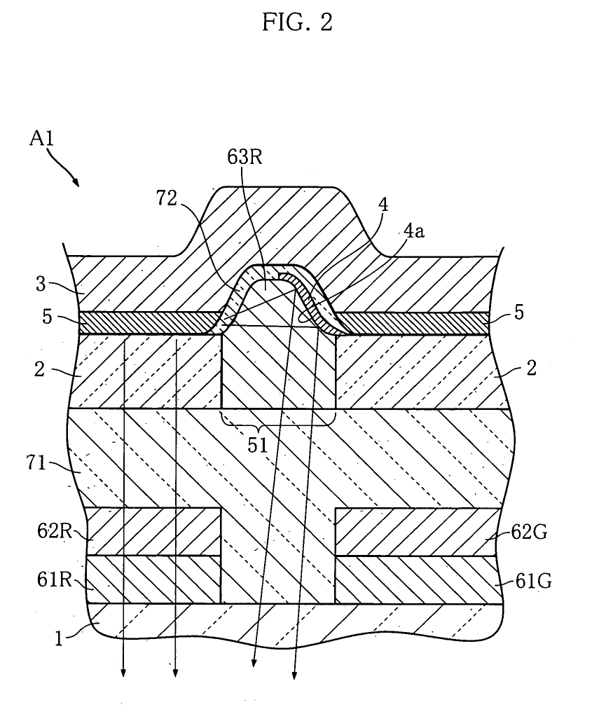

FIGS. 1 and 2 show an organic EL display device according to a first embodiment of the present invention. The organic EL display device A1 of this embodiment includes a substrate 1, an anode electrode 2, a cathode electrode 3, metal members 4, a plurality of light emitting layers 95, color conversion layers 62R, 62G, 63R, 63G and filters 61R, 61G, 61B. The organic EL display device is designed to display a color image at a display region (not shown) oriented downward in the figure.

The substrate 1 supports the anode electrode 2, the cathode electrode 3, the light emitting layers 5 and so on and is made of e.g. glass. The lower surface of the substrate 1 in the figure provides the display region. The organic EL display device A1, including the substrate 1 made of transparent glass, is designed as a bottom emission type which emits light through the substrate 1.

The anode electrode 2 functions to apply an electric field and inject holes into the light emitting layers 5. The anode electrode is electrically connected to the positive electrode of a non-illustrated power supply. The anode electrode 2 is a transparent electrode made of e.g. ITO.

The cathode electrode 3 functions to apply an electric field and inject electrons into the light emitting layers 5. The cathode electrode is electrically connected to the negative electrode of the power supply. The cathode electrode 3 is made of e.g. A1 and has a relatively high reflectivity.

In this embodiment, each of the anode electrode 2 and the cathode electrode 3 comprises a plurality of strips. The strips of the anode electrode 2 and those of the cathode electrode 3 intersect at right angles, and the light emitting layers 5 are provided at the intersecting portions. The organic EL display device A1 having this structure is controlled by the passive matrix method. However, unlike this embodiment, the organic EL display device according to the present invention may be designed to be controlled by the active matrix method.

The light emitting layers 5 emit light when a voltage is applied between the anode electrode 2 and the cathode electrode 3 and serves as the light source of the organic EL display device A1. In this embodiment, the light emitting layers 5 are made of a blue phosphorescence material such as iridium complex to emit blue light. The light emitting layers 5 emit light in the vertical direction and the horizontal direction in the figure. A hole injection layer and a hole transport layer (both not shown) are provided between the light emitting layers 5 and the anode electrode 2. The hole injection layer serves to lower the drive voltage necessary for causing light emission from the light emitting layers 5 and contains e.g. phthalocyanine or oligoamine. The hole transport layer serves to transport the holes from the hole injection layer to the light emitting layers 5 and contains phenylenediamine or other kinds of diamines, for example. An electron injection layer may be provided between the light emitting layers 5 and the cathode electrode 3.

The color conversion layers 62R and 62G are provided below the light emitting layers 5 in the figure. The color conversion layers 62R and 62G perform wavelength conversion with respect to the blue light emitted from the light emitting layers 5 positioned above to emit red light and green light, respectively. The color conversion layers 62R and 62G contain fluorescent materials suitable for the conversion into red light and green light, respectively.

The filters 61R, 61G and 61B are arranged below the light emitting layers 95. Each of the filters 61R, 61G and 61B selectively passes the light in the wavelength range peculiar to the red, green or blue color to enhance the chroma of the color.

The color conversion layers 62R, 62G and the filters 61R, 61G, 61B are covered with a protective layer 71. The protective layer 71 is a transparent insulating film made of e.g. SiO₂.

The light emitting layers 5 are separated from each other by equal spaces 51. Color conversion layers 63R, 63G or insulating layers 73 are arranged in the spaces 51. The color conversion layers 63R and 63G are made of the same material as those of the color conversion layers 62R and 62G, respectively and serve to convert the blue light emitted from the adjacent light emitting layer 5 into red light and green light. The insulating layers 73 are made of a transparent insulating material such as SiO₂ or resist and pass the blue light emitted from the adjacent light emitting layer 5. In this embodiment, all of the color conversion layers 63R, 63G and the insulating layers 73 bulge upward in the figure.

The metal members 4 are provided at an upper portion in the spaces 51. Of the metal members 4, the one formed on the upper surface of a color conversion layer 63R is shown in FIG. 2. The metal member 4 is made of e.g. A1 and has a relatively high reflectivity. In this embodiment, the metal member 4 is formed on the inclined surface of the color conversion layer 63R in the upper right of the figure. The surface of the metal member 4 which is in contact with the color conversion layer 63R is a reflective surface 4a. The reflective surface 4a is so inclined as to come closer to the substrate 1 as proceeding from the light emitting layer 5 on the left side in the figure to the light emitting layer 5 on the right side in the figure. The metal member 4 is insulated from the light emitting layer 5 and the cathode electrode 3 by an insulating layer 72. The plurality of metal members 4 and reflective surfaces 4a shown in FIG. 1 have the substantially same structure as that shown in FIG. 2.

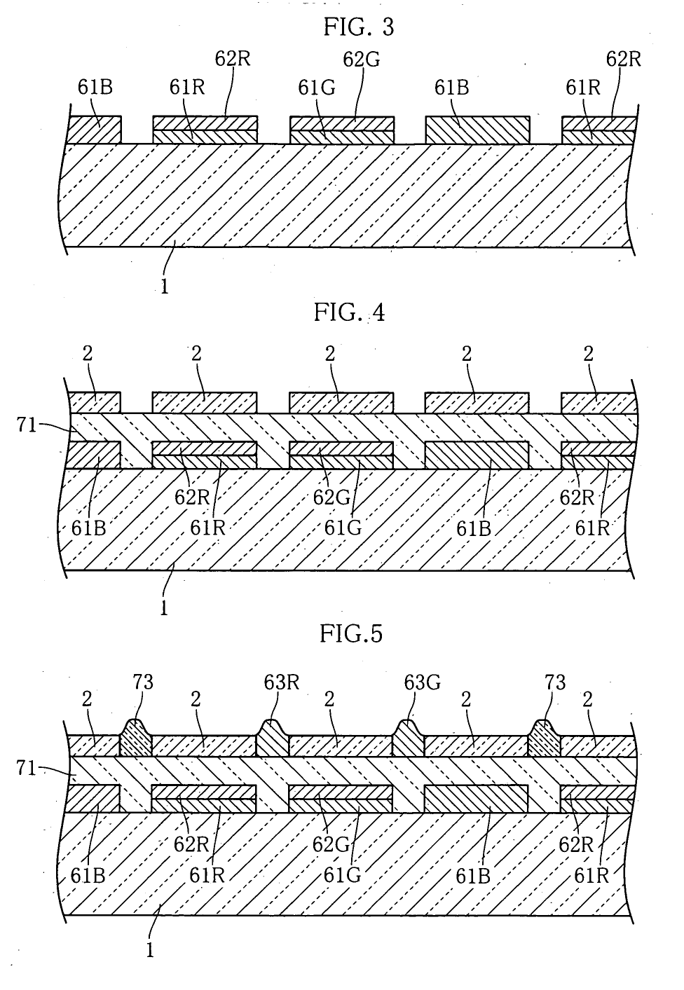

A method for manufacturing the organic EL display device A1 will be described below with reference to FIGS. 3-8.

First, as shown in FIG. 3, a substrate 1 made of glass is prepared. Filters 61R, 61G, 61B and color conversion layers 62R, 62G are formed on the substrate 1. Then, as shown in FIG. 4, a protective layer 71 is formed. Then, a thin film of ITO is formed to cover the protective layer 71. By performing patterning with respect to the thin film of ITO, an anode electrode 2 made up of a plurality of strips is formed.

Then, as shown in FIG. 5, color conversion layers 63R, 63G and insulating layers 73 are formed between the strips of the anode electrode 2.

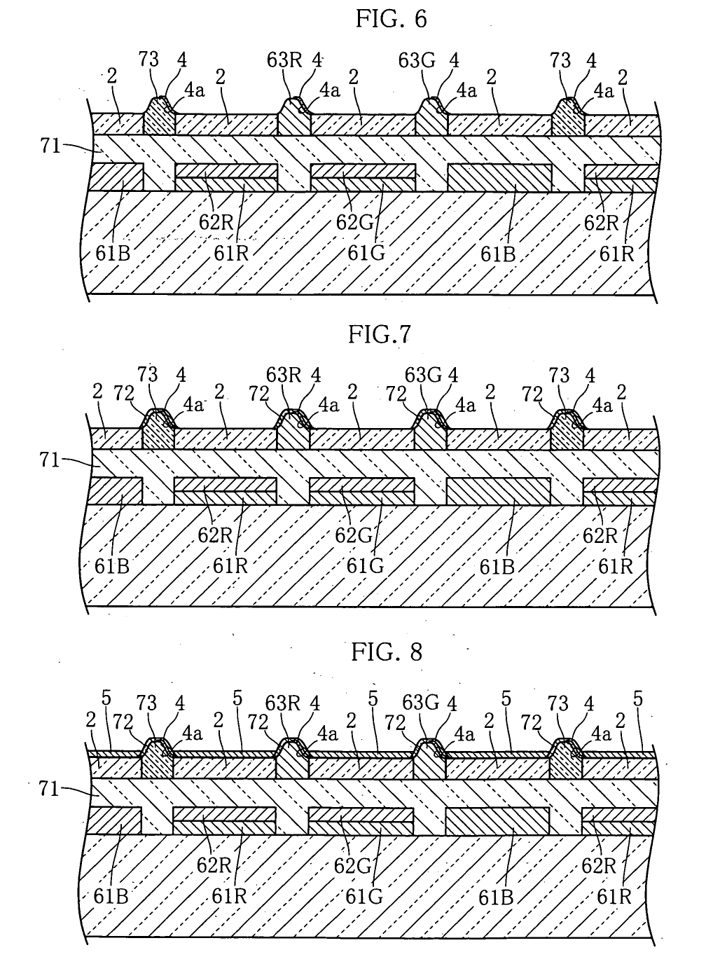

Then, a thin film of A1 is formed to cover the anode electrode 2, the color conversion layers 63R, 63G and the insulating layers 73. The thin film of A1 may be formed by sputtering or vapor deposition. By performing patterning with respect to the thin film of A1, a plurality of metal members 4 are formed, as shown in FIG. 6. Of the metal members 4, the portions which are in contact with the color conversion layers 63R, 63G and insulating layers 73 are reflective surfaces 4a.

Then, an insulating film is formed to cover the color conversion layers 63R, 63G, the insulating layers 73, the metal members 4 and the anode electrode 2. Then, the insulating film is subjected to patterning so that portions of the insulating film covering the color conversion layers 63R, 63G, the insulating layers 73 and the metal members 4 are left. Thus, insulating layers 72 as shown in FIG. 7 are obtained.

Then, a predetermined organic material is laminated to cover the insulating layers 72 and the anode electrode 2. Then, the layer of the organic material is subjected to patterning so that the portions between insulating layers 72 are left. As a result, a plurality of light emitting layers 5 are provided, as shown in FIG. 8. Then, using a shadow mask, a thin film of A1 is formed on the light emitting layers 5 and the insulating layers 72. Thus, the cathode electrode 3 shown in FIG. 1 is obtained. By the process steps described above, an organic EL display device A1 is obtained.

The advantages of the organic EL display device A1 will be described below.

Referring to FIG. 2, when a voltage is applied to the left one of the light emitting layers 5 shown in the figure, blue light is emitted from the light emitting layer 5. Of this light, the light rays emitted upward in the figure are reflected downward by the cathode electrode 3 having a relatively high reflectivity. The reflected light rays and the light rays emitted from the light emitting layer 5 downward in the figure pass through the protective layer 71 and then pass through the color conversion layer 62R to be converted into red light. The red light passes through the filter 61R so that the chroma is enhanced and is then emitted from the lower surface of the substrate 1. On the other hand, the light rays emitted from the light emitting layer 5 rightward in the figure pass through the insulating layer 72 and the color conversion layer 63R to reach the reflective surface 4a. The light rays are reflected by the reflective surface 4a to travel through the color conversion layer 63R downward in the figure. In passing through the color conversion layer 63R, the light rays are converted into red light. The red light travels from the space 51 to pass through the protective layer 71 and the substrate 1 to be emitted from the lower surface of the substrate 1. Although FIG. 2 shows the emission of red light, the emission of green light is performed in the same manner. The emission of blue light is performed in the same manner except that blue light does not pass through a color conversion layer and is not subjected to wavelength conversion. As will be understood from the above, in the organic EL display device A1, not only the light emitted from the light emitting layers 5 in the vertical direction but also the light emitted rightward in the figure are properly emitted downward from the substrate 1. Thus, the organic EL display device A1 provides high brightness.

Further, since the reflective surfaces 4a are provided by the metal members 4 made of A1, the reflectivity of the reflective surfaces 4a is relatively high. This is advantageous for enhancing the brightness of the organic EL display device A1.

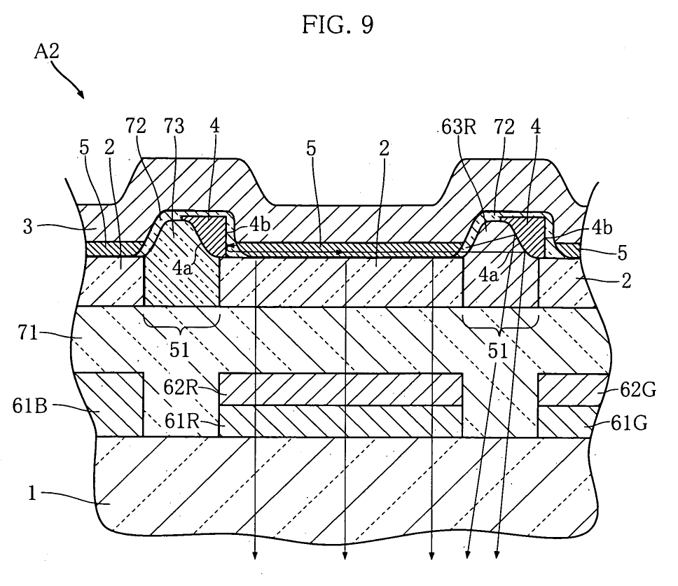

FIGS. 9-12 show other embodiments of the present invention. In these figures, the elements which are identical or similar to those of the foregoing embodiments are designated by the same reference signs as those used for the foregoing embodiment.

FIG. 9 shows an organic EL display device according to a second embodiment of the present invention. The organic EL display device A2 of this embodiment differs from the foregoing embodiment in shape of the metal members 4. Specifically, each of the metal members 4 in this embodiment includes two reflective surfaces 4a and 4b. The reflective surface 4a covers part of the space 51 and functions in the same way as the reflective surface 4a of the foregoing embodiment. The reflective surface 4b comprises the right side surface of the metal member 4 in the figure. Unlike the side surface 4a, the reflective surface 4b extends perpendicularly to the arrangement direction of the light emitting layers 5.

In this embodiment again, the light emitted from the light emitting layer 5 rightward in the figure is reflected by the reflective surface 4a to be emitted downward in the figure. Moreover, according to this embodiment, the light emitted from the light emitting layer 5 leftward in the figure is reflected rightward by the reflective surface 4b of the metal member 4 located on the left side. This light passes through the light emitting layer 5 to impinge on the reflective surface 4a of the metal member 4 located on the right side and is reflected downward by the reflective surface 4a. Then, the light is emitted from the lower surface of the substrate 1. In this way, both of the light emitted rightward and the light emitted leftward from the light emitting layer 5 are reliably emitted downward from the substrate 1. Thus, the organic EL display device A2 provides enhanced brightness.

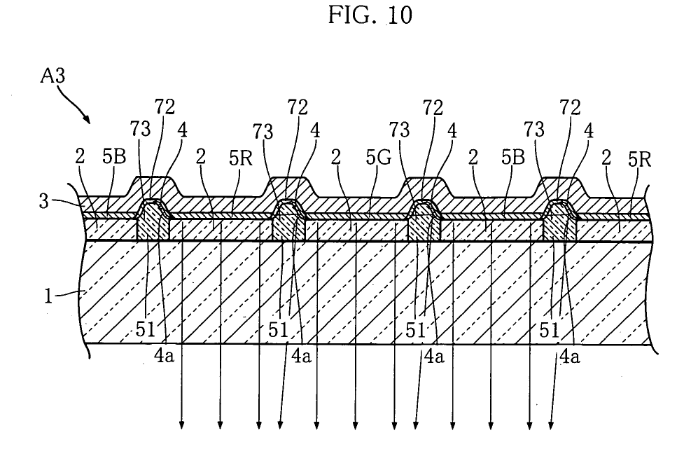

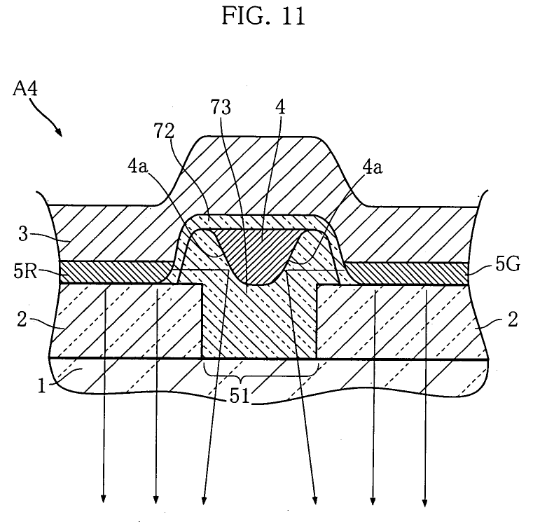

FIG. 10 shows an organic EL display device according to a third embodiment of the present invention, which employs individual RGB color light emitting layers. Unlike the foregoing embodiments, the organic EL display device A3 of this embodiment includes light emitting layers 5R for emitting red light and light emitting layers 5G for emitting green light and does not include color conversion layers, filters and a protective layer. When a voltage is applied through the anode electrode 2 and the cathode electrode 3, the light emitting layers 5R and 5G emit red light and green light, respectively. The organic EL display device further includes light emitting layers 5B for emitting blue light, which may have the same structure as the light emitting layers 5 of the first embodiment. The light emitted from the light emitting layers 5R, 5G, 5B do not need to be subjected to color conversion and pass through a filter. Since a color conversion layer and a filter are unnecessary, a protective layer is also unnecessary. Transparent insulating layers 73 are provided in all the spaces 51 between the light emitting layers 5R, 5G, 5B.

As will be understood from this embodiment, in the organic EL display device according to the present invention, the light of the colors necessary for the image display may be emitted by the light emitting layers 5R, 5G and 5B without using a color conversion technique. The organic EL display device A3 of this embodiment also provides high brightness.

FIG. 11 shows an organic EL display device according to a fourth embodiment of the present invention. The organic EL display device A4 of this embodiment differs from those of the foregoing embodiments in shape of the metal members 4. Similarly to the third embodiment, the organic EL display device of this embodiment includes light emitting layers 5R, 5G, 5B for emitting different colors, and transparent insulating layers 73 are arranged in the spaces 51 between the light emitting layers. Each of the metal members 4 has a center portion bulging toward the substrate 1. With the metal member 4 having this shape, the space 51 is covered with two reflective surfaces 4a of the metal layer 4. The left reflective surface 4a in the figure reflects the light emitted rightward from the red light emitting layer 5R downward in the figure. The right reflective surface 4a in the figure reflects the light emitted leftward from the green light emitting layer 5G downward in the figure.

According to this embodiment, the light emitted toward opposite sides from the light emitting layers 5R, 5G, 5B is properly emitted from the lower surface of the substrate 1. Thus, the organic EL display device A4 of this embodiment also provides high brightness.

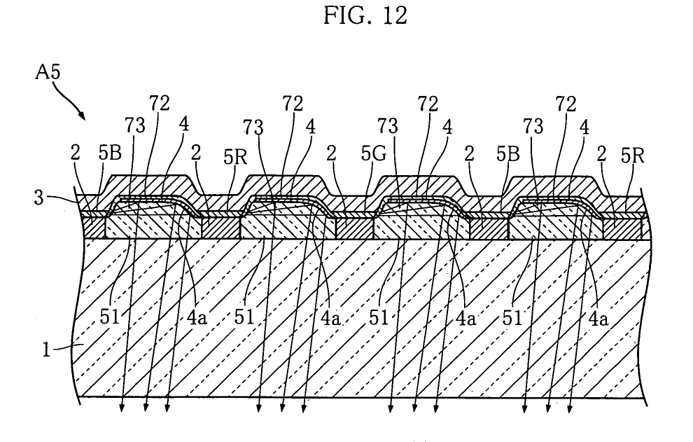

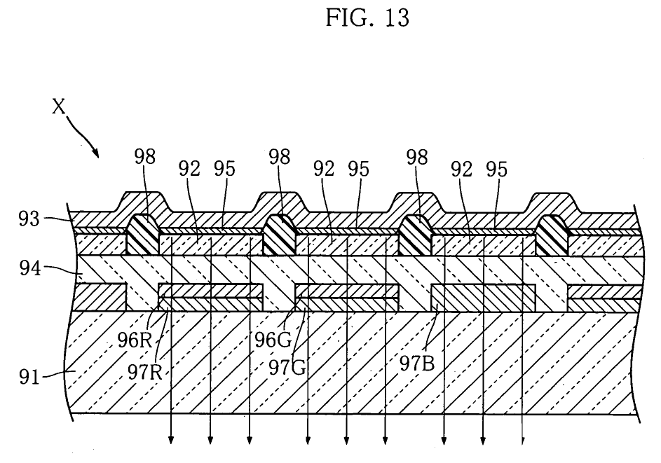

FIG. 12 shows an organic EL display device according to a fifth embodiment of the present invention. The organic EL display device AS of this embodiment differs from the foregoing embodiments in that the anode electrode 2 is opaque. The anode electrode 2 in this embodiment is made of an opaque conductor such as A1, for example. The anode electrode 2 comprises a plurality of strips. The width of each strip of the anode electrode in the right and left direction in the figure is smaller than the space 51.

In this embodiment, the light emitted from the light emitting layers 5R, 5G, 5B rightward in the figure is reflected by the reflective surfaces 4a downward in the figure. The image to be displayed at the display region is formed only by the light reflected in this way. Depending on the-materials and lamination structure of the light emitting layers 5R, 5G, 5B, the luminance of the light emitted in the horizontal direction in the figure may be higher than that emitted in the vertical direction. According to this embodiment, such light having a relatively high luminance is efficiently emitted from the lower surface of the substrate 1. Further, in this embodiment, the light emitted from the light emitting layers 5R, 5G, 5B does not pass through a transparent electrode made of e.g. ITO, so that the attenuation of light is relatively small. This is also advantageous for enhancing the brightness of the organic EL display device AS.

Moreover, since the size of the spaces 51 is larger than the width of the strips of the anode electrode 2, the light from the light emitting layers 5R, 5G, 5B is emitted from a relatively wide region, which also contributes to the enhancement of the brightness of the organic EL display device A5. Further, the structure in which the anode electrode 2, which is not a light emitting region, is relatively small is advantageous for achieving the high definition of the organic EL display device A5.

The organic EL display device according to the present invention is not limited to the foregoing embodiments. The specific structure of each part of the organic EL display device according to the present invention may be varied in design in many ways.

The reflective surface is not limited to that formed by a metal member. For instance, light may be totally reflected at a boundary surface between two transparent members having different indexes of refraction. The light to be emitted from the light emitting layers is not limited to red light, green light and blue light. Further, the organic EL display device according to the present invention is not limited to the structure for displaying a full-color image but may be designed to display a monochromatic image. The arrangement of the anode electrode and the cathode electrode relative to the substrate may be reverse to that of the foregoing embodiments.

1. An organic EL display device comprising:
a transparent substrate;
an anode electrode and a cathode electrode laminated on the substrate; and
a plurality of light emitting layers disposed between the anode electrode and the cathode electrode and made of an organic material;
wherein the plurality of light emitting layers are separated from each other by spaces in an in-plane direction of the substrate,
wherein each of the spaces is covered at least partially by a reflective surface that is inclined to come closer to the substrate as proceeding from one of the light emitting layers toward an adjacent one of the light emitting layers.

2. The organic EL display device according to claim 1, wherein the reflective surface is made of metal.

3. The organic EL display device according to claim 1, further comprising color conversion layers accommodated in the spaces.

4. The organic EL display device according to claim 1, wherein each of the anode electrode and the cathode electrode is made of an opaque conductor.

5. The organic EL display device according to claim 4, wherein one of the anode electrode and the cathode electrode is closer to the substrate than the other is, the closer one being smaller in size than each of the spaces in the direction in which the light emitting layers are separated from each other.
